(19) United States
(12) Patent Application Publication
(10) Pub. No.: US 2010/0237657 A1
(43) Pub. Date: Sep. 23, 2010

(54) Truck floor assembly

(75) Inventor: Charles L. Hanley, Woonsocket, RI (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Dejana Cargo & Van Interiors Inc., Rosedale, MD (US)

(21) Appl. No.: 12/383,054

(22) Filed: Mar. 19, 2009

(51) Int. Cl. B62D 25/20

(52) U.S. Cl. 296/193.07

(57) ABSTRACT

A floor filler plate assembly for use with a floor in a vehicle. The assembly includes a floor filler plate pan having a horizontal portion and a vertical portion joined together at a junction to form an enclosed area. At least one end panel attached to at least one of the horizontal and vertical portions on at least one of the curbside and roadside end to form a closed floor filler plate pan. A stiffener is also provided at the junction for added strength. The assembly may be fixedly mounted to the floor with other objects fastened to it.

### BACKGROUND

The present invention relates to a truck floor assembly. More particularly it relates to a container that serves as storage space and an attachment point for other items to be mounted in the vehicle.

Trucks and other vehicles often are manufactured in a generic condition and are customized or added to when sold to a specific industry. For example, construction company trucks have special boxes and racks to store tools and equipment, and to provide access to them. Delivery trucks have different requirements.

Sometimes all that is delivered from the vehicle manufacturer is the chassis of the truck. Other times, production vehicles such as vans are delivered and customized. It would be a great advance in the trucking industry if a device could be provided for basic vehicles such as vans that would provide storage space for the driver and at the same support a wide variety of different boxes, racks and other units as needed by specific users.

### SUMMARY

The present invention is a truck floor assembly that serves as a primary storage container and as a floor mounting that accommodates other equipment such as racks and shelves. The assembly includes a floor filler plate pan, end panels for both roadside and curbside, and a floor filler plate stiffener. The assembly is sized to fit behind the front seats of a vehicle, such as a van or panel truck in the space where a second seat would be placed, such that it fits down into the space where the person or persons using the seat, if it had not been removed, would place their feet. For purposes of clarity, the area where the seat would be placed is defined as the raised floor portion of the vehicle and the area where the feet would be put is defined as the lower floor portion of the vehicle.

The floor filler plate pan includes a flat, horizontal portion extending over the lower floor portion and may be attached to the upper floor portion. The floor filler plate pan also includes a vertical portion extending down from the horizontal portion to the floor to the lower floor portion. The vertical portion may have one or more openings facing the driver's seat to provide secure storage access to the inside of the assembly.

A stiffener may be added to further strengthen the assembly, such as at the bend where the horizontal portion is joined to the vertical portion. Either the curbside or the roadside end panels may include a hinge or other device for permitting access to the inside of the assembly.

### BRIEF DESCRIPTION OF THE DRAWINGS

FIG. 1 is a perspective view of the assembly of this invention.

FIG. 2 is a perspective view of one component of the assembly.

FIG. 3 is a perspective view of the assembly of this invention in a vehicle.

### DETAILED DESCRIPTION

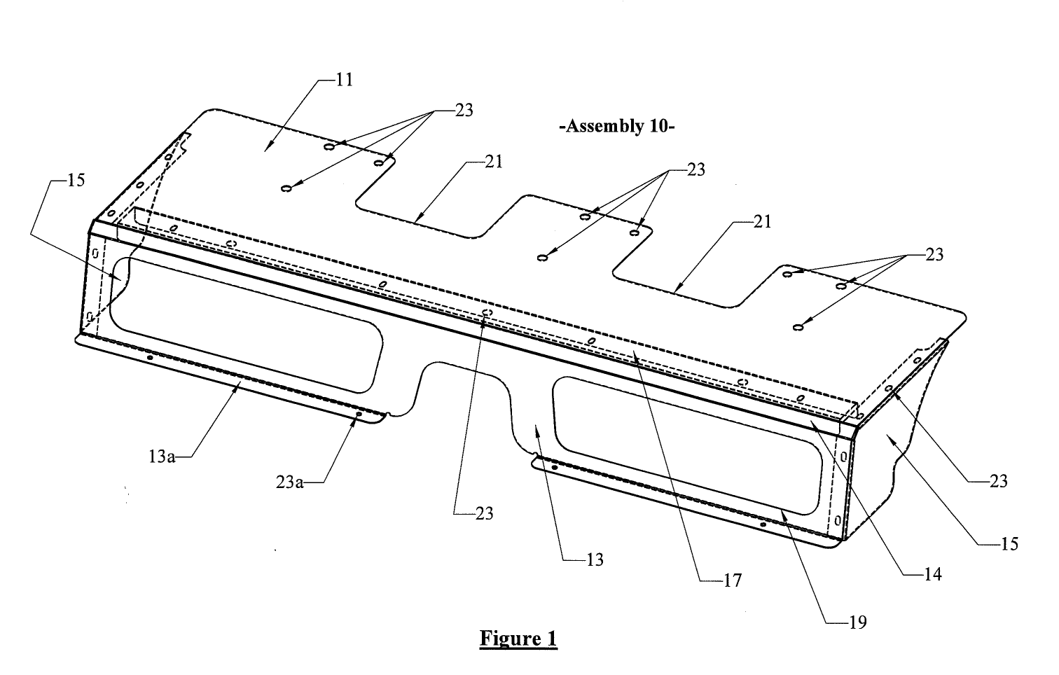

FIG. 1 illustrates the assembly 10 of this invention. Assembly 10 is formed from a sturdy material that will support weight and will have strength to have other elements attached to it. Cold rolled steel is a suitable material for all of the components of the assembly. 16 gauge smooth, cold rolled steel is preferred. Other materials with adequate strength are also within the scope of this invention.

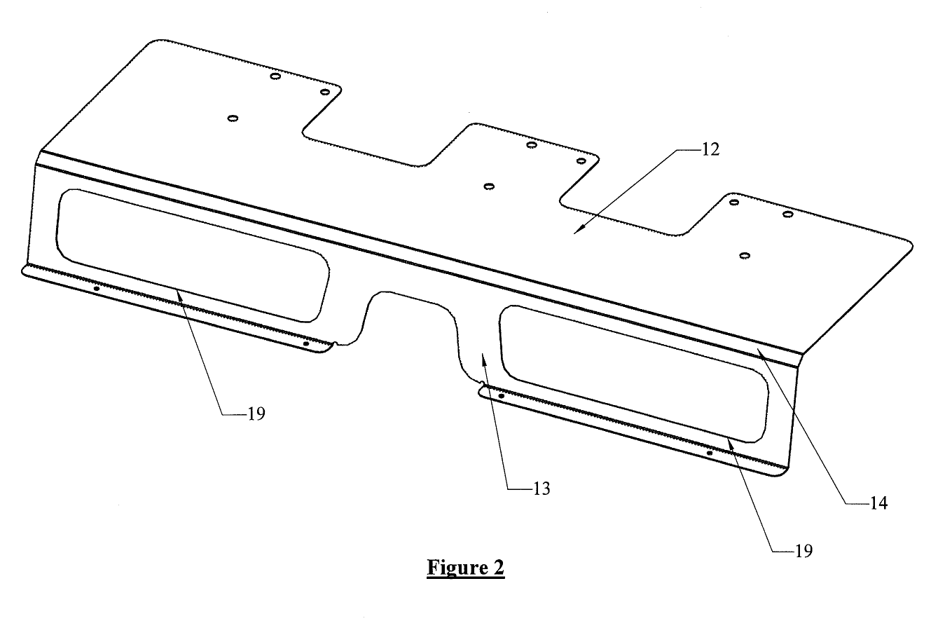

Assembly 10 includes a floor filler plate pan 11 with a top or horizontal portion 12 and a front or vertical portion 13 joined together to form a junction 14 in the shape of a “L” shape as seen in FIG. 2. End panels 15 are provided on at least one end of horizontal portion 12 and/or vertical portion 13 to enclose the underside of the assembly and provide a secure storage compartment. FIG. 1 shows both curbside and roadside end plates 15. If desired, end plates can have a hinge or latch to permit them to open as doors, for additional access to the storage compartment. Stiffener 17 is optionally provided to give increased strength in applications where a significant weight or tension will be encountered by assembly 10. Stiffener 17 may be mounted on the underside of junction 14 as shown. Open areas 19 provide access to the storage area. Cut outs 21 are designed to mate with the vehicle floor.

Assembly 10 is fastened together at fastening points 23 by welding, riveting, bolts and nuts or other conventional methods of attaching parts, particularly metal parts. The parts may be treated with an urethane seam sealer at interior joints prior to painting to increase sound deadening, if desired. The specific color of paint will be determined by the color of the vehicle or by other factors.

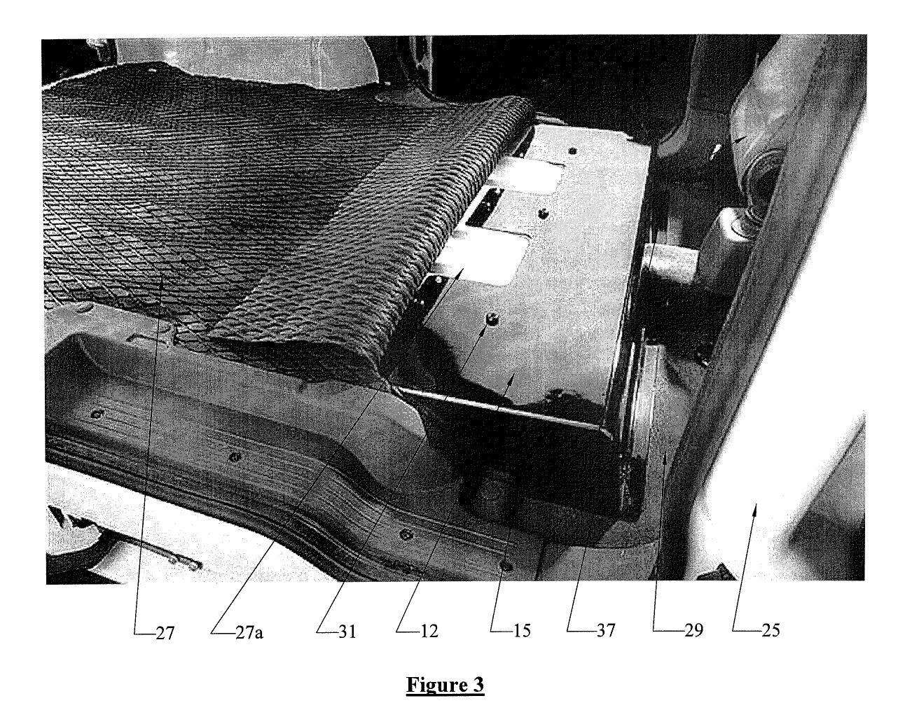

FIG. 3 illustrates assembly 10 installed in a vehicle such as van 25 with van floor 27 being raised up and the floor area 29 where a person occupying a second row seat, not shown, would put his or her feet. The second row seating is not reinstalled because the assembly 10 fills the existing rear foot well to gain additional room in the cargo area. Floor 27 is above floor area 29 by a distance equal to the height of vertical portion 13 at the front of assembly 10 and extends to the back of van 25. Cut outs 21 engage extensions 27a of floor 27, and fasteners 31 attach assembly 10 to floor 27. Fasteners 31 are removable so that assembly 10 can be removed if desired. In operation, assembly 10 is fixedly mounted to floor 27 and remains in place during use. Other equipment such as racks, shelves, boxes and tools may be attached to assembly 10 as desired.

FIG. 1 shows a vertical portion 13 with lip 13a and fastening points 23a for attachment to a floor of a vehicle, such as floor 29 in van 25 shown in FIG. 3.

The assembly of the present invention allows vans and other vehicles to be generically converted into vehicles that can serve a wide variety of needs, depending on the specific business operations that the owner or user has. The assembly can also be used on recreational and pleasure vehicles where a flat floor is desired and only the front seats are needed.

Although the present invention has been described with reference to preferred embodiments, workers skilled in the art will recognize that changes may be made in form and detail without departing from the spirit and scope of the invention.

1-20. (canceled)

21. A floor filler plate assembly for use with a floor in a truck, comprising:
a truck having front seat and a raised floor extending from the back of the truck to a point spaced from a point proximate the front seat by a predetermined distance and a lower floor between the point spaced from the front seat and the point proximate the front seat;
a floor filler plate pan having a horizontal portion and a vertical portion joined together at a junction to form an enclosed area having a curbside end and a roadside end, the horizontal portion extending from proximate the point spaced from the front seat down to a point proximate the lower floor and the vertical portion spaced from the point spaced from the front seat to the point proximate the front seat; and
at least one end panel attached to at least one of the horizontal and vertical portions at at least one of the curbside end and the roadside end to form a closed floor filler plate pan.

22. The assembly of claim 21, wherein the assembly is fixedly mounted to the floor of the vehicle.

23. The assembly of claim 22, wherein both the horizontal and vertical portions are fixedly mounted to the floor in the truck.

24. The assembly of claim 21, wherein the vertical portion includes an open area sufficient to provide access to the area enclosed by the horizontal and vertical portions.

25. The assembly of claim 21, wherein the truck is a van having a raised floor approximately as high as the vertical portion of the assembly and a lower floor behind the front seat at least as wide as the horizontal portion of the assembly.

26. The assembly of claim 25, wherein the horizontal portion of the assembly is fixedly mounted to the raised floor and the vertical portion of the assembly is fixedly mounted to the lower floor.

27. The assembly of claim 21, which further includes a stiffener element mounted at the junction to increase the stiffness of the assembly.

28. The assembly of claim 27, wherein the stiffener is fixedly mounted to the junction.

29. The assembly of claim 21, which includes a fixedly mounted end plate at the curbside and the roadside ends of the assembly.

30. A method of extending the useable floor space of a a truck having front seat and a raised floor extending from the back of the truck to a point spaced from a point proximate the front seat by a predetermined distance and a lower floor between the point spaced from the front seat and the point proximate the front seat comprising the steps of:
providing an assembly including a floor filler plate pan having a horizontal portion and a vertical portion joined together at a junction to form an enclosed area and a curbside end and a roadside end, the vertical portion having an open area sufficient to provide access to the area enclosed by the horizontal and vertical portions, the horizontal portion extending from proximate the point spaced from the front seat down to a point proximate the lower floor and the vertical portion spaced from the point spaced from the front seat to the point proximate the front seat; and
attaching at least one end panel to at least one of the horizontal and vertical portions on at least one of the curbside end and the roadside end to form a closed floor filler plate pan.

31. The method of claim 30, wherein the assembly is fixedly mounted to the floor in the truck.

32. The method of claim 30, wherein the vertical portion includes an open area sufficient to provide access to the area enclosed by the horizontal and vertical portions.

33. The method of claim 30, wherein the truck is a van.

34. The method of claim 33, wherein the horizontal portion of the assembly is fixedly mounted to the raised floor and the vertical portion of the assembly is fixedly mounted to the lower floor.

35. The method of claim 30, which further includes the step of providing a stiffener fixedly mounted to the junction of the horizontal and vertical portions.

36. The method of claim 30, which further includes the step of closing the curbside end and the roadside end of the assembly to provide storage space inside the assembly.
